(19) United States
(12) Patent Application Publication
(10) Pub. No.: US 2008/0066990 A1
(43) Pub. Date: Mar. 20, 2008

(54) Vehicular hydraulic system with pressure reducing valve

(76) Inventors: Albert C. Wong, Saginaw, MI (US); James L. Davison, Freeland, MI (US); Rick L. Lincoln, Linwood, MI (US)

Correspondence Address: MICHAEL D. SMITH;DELPHI TECHNOLOGIES, INC., P.O. BOX 5052, MAIL CODE: 480-410-202, TROY, MI, 48007-5052, US

(21) Appl. No.: 11/901,949

(22) Filed: Sep. 19, 2007

Related U.S. Application Data
(60) Provisional application No. 60/846,004, filed on Sep. 20, 2006.

(51) Int. Cl. B62D 5/07; B60T 13/128

(52) U.S. Cl. 180/442; 303/9.61

(57) ABSTRACT

A vehicular hydraulic system having a hydraulic pump, an optional flow-splitting valve, a first hydraulic application, a pressure reducing valve and a second hydraulic application arranged in series along a primary flow path. When the pressure in the primary flow path between the pump and first application is elevated to a first threshold value, the flow-splitting valve, if present, splits the fluid discharged by the pump into a first fluid flow communicated to the primary flow path upstream of the first application and a second fluid flow communicated to the primary flow path between the first application and the pressure-reducing valve. The pressure reducing valve limits the maximum pressure of the fluid discharged therefrom to a second threshold value wherein the first threshold value is greater than the second threshold value. The first and second hydraulic applications may take the form of a brake booster and a steering gear, respectively.

### CROSS REFERENCE TO RELATED APPLICATIONS

This application claims priority under 35 U.S.C. 119(e) of U.S. provisional patent application Ser. No. 60/846,004 filed on Sep. 20, 2006 entitled VEHICULAR HYDRAULIC SYSTEM WITH PRESSURE REDUCING VALVE the disclosure of which is hereby incorporated herein by reference.

### BACKGROUND OF THE INVENTION

1. Field of the Invention

The present invention relates to hydraulic systems for vehicles and, more particularly, to a hydraulic system having a hydraulic fluid pump and at least one hydraulic device.

2. Description of the Related Art

Many trucks with hydraulic braking systems, particularly larger gasoline powered and diesel powered trucks, incorporate hydraulic braking assist systems, rather than vacuum assist systems commonly found in passenger automobiles. The use of vacuum assist braking systems can be problematic in vehicles having a turbo-charged engine and such vehicles will also often employ hydraulic braking assist systems. Furthermore, there is an aftermarket demand for hydraulic braking assist systems for vehicles, such as hotrods, that may not otherwise have a brake assist device or for which the use of a vacuum assist system presents difficulties. Such hydraulic braking assist systems are well known and sold commercially.

Typically, these hydraulic braking assist systems are connected in series between the steering gear and hydraulic pump and use flow from the pump to generate the necessary pressure to provide brake assist as needed. The flow from the pump is generally confined within a narrow range of flow rates and is not intentionally varied to meet changing vehicle operating conditions. Because of the series arrangement, the application of the brakes and engagement of the hydraulic braking assist system can affect the flow of hydraulic fluid to the steering gear, thereby affecting the amount of assist available to the steering gear. Specifically, when a heavy braking load is applied, it causes an increase in backpressure to the pump which can exceed a threshold relief pressure (e.g., 1,500 psi) of the pump. Above this level, a bypass valve of the pump opens to divert a fraction of the outflow back to the intake of the pump, where the cycle continues until the pressure from the brake assist device drops below the threshold value of the bypass valve. During this relief condition, a diminished flow of fluid is sent to the steering gear which may result in a detectable increase in steering effort by the operator of the vehicle to turn the steering wheel under extreme relief conditions.

To at least partially alleviate this condition, it is possible to place a flow-splitter or priority valve in the hydraulic system to divert a portion of the flow of fluid being discharged from the pump to the steering gear under heavy braking conditions. The disclosure of U.S. Pat. No. 6,814,413 B2 describes the use of such a flow-splitter and is hereby incorporated herein by reference. While the use of a flow splitter to divert a portion of the fluid flow being discharged by the pump to the steering gear assist device during heavy braking conditions provides significant advantages, the use of such a flow splitter generally requires that the steering gear device have a pressure relief value that is at least large as the pressure relief value of the brake assist device.

Oftentimes, a steering gear assist device that is adequate for a particular vehicle will have a lower pressure relief value than the brake assist device required for that same vehicle. Thus, the requirement that the steering gear assist device have a pressure relief value that is at least as large as the pressure relief value of the brake assist device often has a direct impact on the selection of a steering gear assist device and results in the selection of a more expensive steering gear assist device.

### SUMMARY OF THE INVENTION

The present invention provides a hydraulic brake and steering assist system having a priority valve and pressure reduction valve that allows a steering gear assist device having a lower pressure relief value than the brake assist device to be arranged in series with the brake assist device.

The invention comprises, in yet another form thereof, a vehicular hydraulic system that includes a hydraulic circuit having, arranged in series and in serial order along a primary flow path, a hydraulic pump, a first hydraulic application, a pressure reducing valve and a second hydraulic application wherein the hydraulic fluid pressure in the primary flow path between the hydraulic pump and the first hydraulic application can be elevated to a first threshold value. The pressure reducing valve limits the maximum pressure of the hydraulic fluid discharged from the pressure reducing valve to a second threshold value wherein the first threshold value is greater than the second threshold value.

The invention comprises, in one form thereof, a vehicular hydraulic system that includes a hydraulic circuit having, arranged in series and in serial order along a primary flow path, a hydraulic pump, a flow-splitting valve, a first hydraulic application, a pressure reducing valve and a second hydraulic application. In a first operating condition, substantially all of the hydraulic fluid discharged from the hydraulic pump flows along the primary flow path through the flow-splitting valve, to the first hydraulic application, through the pressure reducing valve, to the second hydraulic application and is returned to the hydraulic pump. When the hydraulic fluid pressure in the primary flow path between the hydraulic pump and the first hydraulic application is elevated to a first threshold value, the flow-splitting valve splits the hydraulic fluid discharged by the hydraulic pump into a first fluid flow which is communicated to the primary flow path upstream of the first hydraulic application and a second fluid flow which is communicated to a point in the primary flow path downstream of the first hydraulic application and upstream of the pressure-reducing valve. The pressure reducing valve limits the maximum pressure of the hydraulic fluid discharged from the pressure reducing valve to a second threshold value wherein the first threshold value is greater than the second threshold value.

In some embodiments of the invention, the first hydraulic application may take the form of a hydraulic brake booster device and the second application may take the form of a hydraulic steering gear device to thereby provide a vehicular hydraulic system with a serially arranged brake booster and steering gear wherein the steering gear has a lower pressure relief value than the brake booster.

An advantage of the present invention is that it provides an efficient and relatively simple hydraulic vehicular hydraulic system that may include a first hydraulic application having a greater pressure relief value than a second hydraulic application that is arranged in series with the first application.

Another advantage of the present invention is that it allows for the combination of a steering gear assist device and a brake assist device wherein the steering gear assist device has a lower hydraulic pressure relief value and thereby provides cost savings in comparison to a vehicular hydraulic system having a steering gear assist device with a larger than necessary hydraulic pressure relief value that is at least as large as the pressure relief value of the brake assist device.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a schematic view of a hydraulic system in accordance with the present invention.

FIG. 2 is a partial cross sectional view of a priority or flow-splitting valve under normal flow conditions.

FIG. 3 is a partial cross sectional view of the priority valve of FIG. 2 wherein the priority valve is diverting a portion of the fluid flow through port C.

FIG. 4 is a schematic partial cross sectional view of a pressure reduction valve under normal flow conditions.

FIG. 5 is a schematic partial cross sectional view of a pressure reduction valve under high pressure conditions.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION OF THE INVENTION

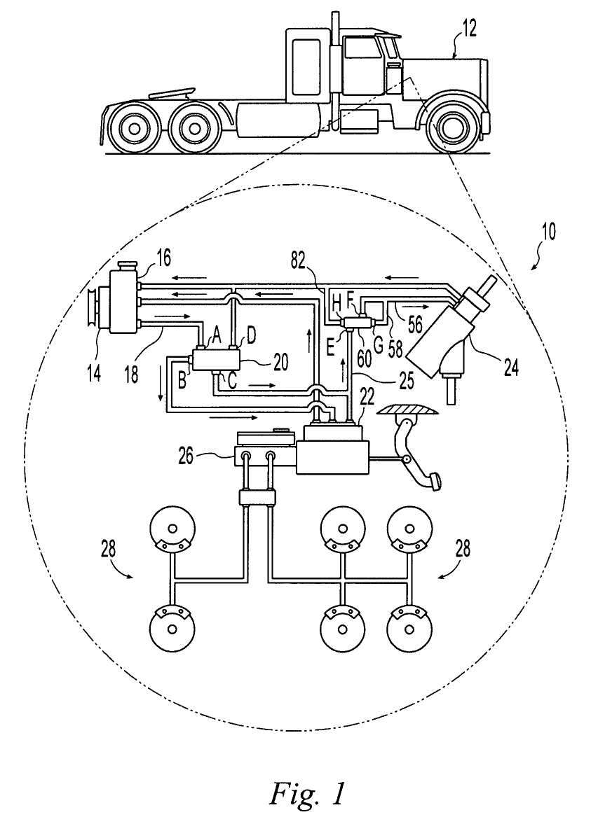

FIG. 1 shows a hydraulic system 10 for a vehicle 12 for assisting in the steering and braking of the vehicle. The hydraulic system includes a hydraulic pump 14 and reservoir 16. The reservoir may be incorporated into the pump 14, as illustrated, or may be located remote from the pump 14.

The pump 14 delivers high pressure hydraulic fluid through discharge line 18 to a flow-splitting valve 20 also known as a priority valve. The priority valve 20, in turn, selectively communicates with a first hydraulic application 22, a second hydraulic application 24, and the reservoir 16, depending on predetermined operating conditions of the system 10, as will be explained below.

The first and second hydraulic applications 22, 24 take the form of a hydraulic device or a hydraulic sub-circuit. In the illustrated embodiment, first application 22 is a hydraulic braking assist system or booster device, and the second application 24 is a hydraulic steering gear assist system or device.

The hydraulic brake booster device 22 communicates with a master cylinder 26 and brakes 28 of the braking system. Hydraulic booster device 22 is of a type well known in the art which is disposed in line between the hydraulic pump and the hydraulic master cylinder of a vehicular hydraulic brake system which acts to boost or amplify the force to the brake system in order to reduce brake pedal effort and pedal travel required to apply the brakes as compared with a manual braking system. Such systems are disclosed, for example, in U.S. Pat. Nos. 4,620,750 and 4,967,643, the disclosures of which are both incorporated herein by reference, and provide examples of a suitable booster device 22. Briefly, hydraulic fluid from the supply pump 14 is communicated to the booster device 22 through a booster inlet port and is directed through an open center spool valve slideable in a booster cavity (not shown). A power piston slides within an adjacent cylinder and is exposed to a fluid pressure on an input side of the piston and coupled to an output rod on the opposite side. An input reaction rod connected to the brake pedal extends into the housing and is linked to the spool valve via input levers or links. Movement of the input rod moves the spool valve, creating a restriction to the fluid flow and corresponding boost in pressure applied to the power piston. Steering pressure created by the steering gear assist system 24 is isolated from the boost cavity by the spool valve and does not affect braking but does create a steering assist backpressure to the pump 14. The priority valve 20 operates to manage the flow of hydraulic fluid from the pump 14 to each of the brake assist 22 and steering assist 24 systems in a manner that reduces the interdependence of the steering and braking systems on one another for operation.

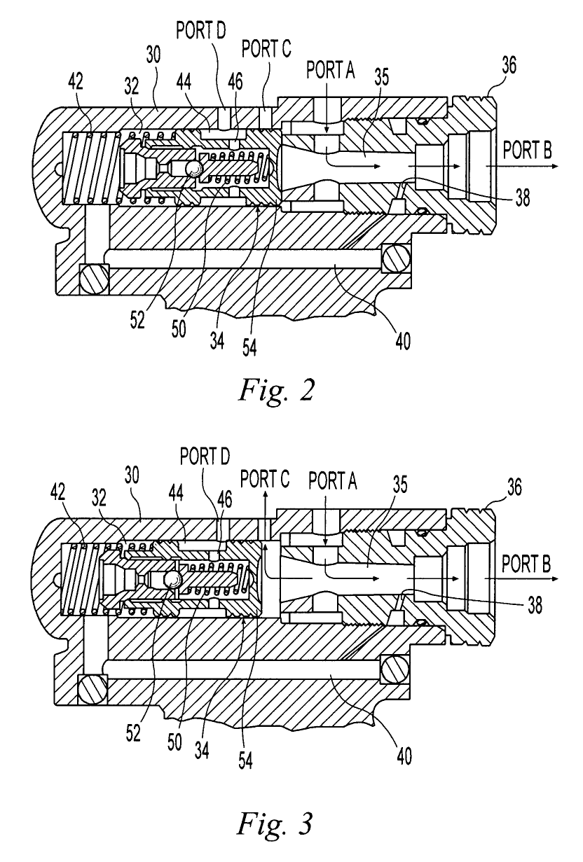

With reference to FIGS. 2 and 3, priority valve 20 includes a valve body 30 having a valve bore forming a chamber 32 in which a slideable flow control valve member 34 is accommodated. A plurality of ports are provided in the valve body 30, and are denoted in the drawing Figures as ports A, B, C and D. Fluid from the pump 14 is directed into the valve body 30 through port A, where it enters the chamber 32 and is directed out of the body 30 through one or more of the outlet ports B, C and D, depending upon the operating conditions which will now be described.

FIG. 2 shows normal operation of priority valve 20 under conditions where backpressure from the brake assist device 22 is below a predetermined threshold or control pressure. All of the flow entering port A passes through a primary channel 35 of the bore 32 of the flow splitter 20 and is routed through port B to the hydraulic brake booster 22. Of course, for all real devices, there is some inherent loss of fluid due to clearances between individual parts.

In the condition illustrated in FIG. 2, brake assist 22 is operating below the predetermined threshold or relief pressure value and the fluid flows freely into Port A and out Port B through the channel 35. As shown, the valve body 30 may be fitted with a union fitting 36 which extends into valve bore 32 and is formed with primary channel 35 in direct flow communication with valve bore 32. The line pressure in the primary channel 35 is communicated through a pressure reducing or P-hole orifice 38 in union fitting 36 and a communication passage 40 in the valve body 30 to the back of the flow control valve 34. This pressure, along with the bias exerted by a flow control spring 42 holds valve member 34 forward against union fitting 36. In this position, valve member 34 completely covers the bypass ports C, D to the steering assist 24 and reservoir 16, respectively, such that flow neither enters nor leaves these two ports. The valve member 34 has a reservoir pressure communication groove 44 that is always exposed to Port D and thus to the reservoir pressure regardless of the position of valve member 34. This reservoir pressure is communicated to the inside of the valve through opening 46. A small poppet valve 50 separates the fluid at line pressure behind the valve member 34 from the fluid at the reservoir pressure inside valve member 34.

Turning now to FIG. 3, the condition is shown where the brake assist pressure developed by brake assist device 22 within Port B and the primary channel 35 exceeds the predetermined threshold pressure value for brake assist device 22, which is preferably set just below the relief pressure of pump 14. As the backpressure in primary channel 35 approaches the predetermined control pressure, the fluid pressure communicated to the back side of flow control valve member 34 will unseat a poppet ball 52 of poppet valve 50 which will cause some of the hydraulic oil to bleed behind the plunger 54 of valve member 34 and out to reservoir 16 through opening 46 in valve member 34 and Port D. Since P-hole orifice 38 is quite small, the communication passage pressure 40 will be lower than the line pressure within the primary channel 35 as long as the poppet valve 50 is open and bleeding oil from behind plunger 54. This pressure differential will cause plunger 54 to slide back against spring 42 from the position shown in FIG. 2 to the position shown in FIG. 3, thereby exposing Port C to the main flow of fluid discharged by pump 14 coming in through Port A. The flow from pump 14 in through Port A will thus be fed to both Port B and Port C with a significant majority of the flow being discharged through Port C bypassing the brake assist device 22 and being delivered to steering gear assist device 24 through hydraulic line 25. The flow control valve 34 thus operates to automatically meter excess oil flow through Port C when the backpressure generated by the brake assist device 22 rises to the preset control pressure which, as mentioned, is preferably set just under the relief pressure of the pump 14.

Priority valves having a different construction that divert hydraulic fluid flow such that the diverted fluid bypasses brake assist device 22 and is delivered to steering gear assist device 24 may also be employed with the present invention. For example, priority valves having a simplified construction that can be substituted for the illustrated priority valve 20 are described by Wong et al. in a U.S. Utility patent application (Ser. No. ______) entitled VEHICULAR HYDRAULIC SYSTEM WITH PRIORITY VALVE AND RELIEF VALVE having an Attorney Docket Number of DP-315726 and claiming priority from U.S. Provisional Application Ser. No. 60/845,911 filed Sep. 20, 2006; and by Wong et al. in a U.S. Utility patent application (Ser. No. ______) entitled VEHICULAR HYDRAULIC SYSTEM WITH PRIORITY VALVE having an Attorney Docket Number of DP-315727 and claiming priority from U.S. Provisional Application Ser. No. 60/845,892 filed Sep. 20, 2006, both of these utility patent applications having a common filing date with the present application, and wherein both of the utility applications and both of the provisional applications are assigned to the assignee of the present application and wherein each of these four utility and provisional applications are expressly incorporated herein by reference.

A pressure reducing valve 60 is located in hydraulic line 25 which conveys hydraulic fluid from brake assist device 22 and Port C to steering gear assist device 24. The illustrated pressure reducing valve 60 is a pilot operated, sliding spool valve and is placed in line 25 before steering gear assist device 24. Valve 60 includes a valve body 62 that defines a valve chamber 62 and Ports E (inlet port), F (outlet port) and G (pilot port) which open into valve chamber 62. Threaded plug or member 78 has a bore 80 that extends through its length and defines Port H (low pressure port). As can be seen in FIG. 1, fluid from Port C of priority valve 20 combined with fluid discharged from brake assist device 22 enters valve chamber 62 through Port E. Fluid is discharged from valve chamber 62 through Port F. Hydraulic line 56 communicates hydraulic fluid from Port F to steering gear device 24 while pilot line 58 communicates the pressure of the fluid in hydraulic line 56 to Port G. Hydraulic line 82 provides fluid communication between Port H and reservoir 16.

Valve 60 also includes a double-headed spool valve member 64 located in valve chamber 62. Spool member 64 includes a first plunger head 66 and a second plunger head 68. The first and second plunger heads 66, 68 sealingly engage the sidewalls of valve chamber 62 and sealingly partition valve chamber 62 into a central portion 70, a pilot portion 72 and a low pressure portion 74. First plunger head 66 faces Port G while second plunger head 68 is engaged by biasing member 76 which takes the form of a helical spring in the illustrated embodiment. Threaded plug 78 is located in the open end of valve chamber 62 and engages the opposite end of spring 76.

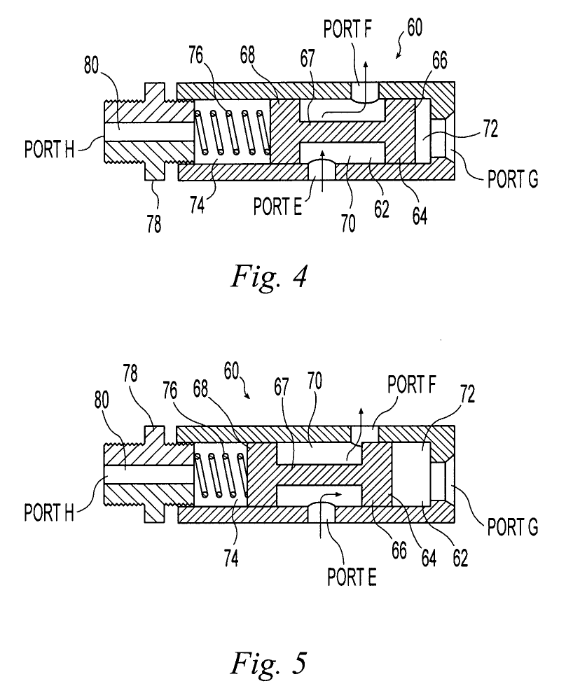

Under low pressure conditions, as exemplified by FIG. 4, first plunger head 66 obstructs only a minimal portion or no portion of Port F. In this low pressure condition, fluid entering through Port E enters central portion 70 of valve chamber 62, flows around stem 67 of spool member 64 that connects the first and second plunger heads, and is discharged through Port F resulting in only a minimal reduction of pressure of the fluid as it passes through valve 60. When the pressure in line 56 which is in communication with the inlet to steering assist device 24 increases relative to the fluid pressure in low pressure portion 74, due to a load being placed on device 24 or for some other reason, this increase in pressure is communicated through pilot line 58 through Port G where it acts on first plunger head 66. The fluid pressure in pilot portion 72 of valve chamber 62 biases the spool member 64 in a direction opposite to that of the bias force exerted by spring 76 and the fluid in the low pressure or spring portion 74 which is at a pressure approximately the same as reservoir 16. As the pressure in pilot portion 72 increases, spool member 64 is biased towards plug 78 as illustrated in FIG. 5. As spool member 64 slides toward plug 78, first plunger head 66 further obstructs Port F and thereby restricts the flow of fluid through valve 60 and causes a greater reduction of pressure in the fluid flowing through valve 60 and serves to limit the maximum pressure in hydraulic line 56 which feeds hydraulic fluid to steering gear assist device 24. As discussed above, valve 60 thereby limits the pressure of the fluid flowing therethrough to a set maximum pressure of the fluid discharged from valve 60 through Port F. Thus, valve 60 can be selected so that maximum pressure of the fluid in hydraulic line 56 is less than the maximum pressure of the hydraulic fluid that is allowed to enter brake assist device 22. Consequently, hydraulic system 10 can employ a steering gear device 24 having a lower pressure limit value than that of the brake assist device 22.

As evident from the description presented above, hydraulic circuit 10 includes, in series arrangement and serial order, hydraulic pump 14, flow-splitting valve 20, brake booster device 22, pressure-reducing valve 60, steering gear device 24 and reservoir 16. When flow splitter 20 is not diverting a portion of the fluid flow through Port C to bypass brake booster 22 as occurs when brake booster 22 is generating a relatively high back pressure, a substantial majority of the fluid flow discharged from pump 14 will flow along a primary flow path that extends from the outlet of pump 14, through discharge line 18, through valve 20 from Port A to Port B, to brake booster 22, to Port E of valve 60, through valve 60 from Port E to Port F, through line 56 to steering gear 24, to reservoir 16 and then to the inlet of pump 14 wherein the cycle is repeated. As described above, when the pressure upstream of brake booster 22 is elevated to first threshold value, flow-splitting valve 20 will split the fluid flow with a portion being communicated to Port B in the primary flow path upstream of brake booster 22 and another portion of the fluid flow being diverted through Port C to a point in the primary flow path downstream of brake booster 22 and upstream of valve 60.

It is noted that the reducing valve 60 illustrated in FIGS. 4 and 5 is an adjustable valve and includes a plug 78 having threads for engaging both the body of valve 60 and a fitting on line 82. The threaded nature of plug 78 permits the external adjustment of valve 60 and the conditions at which valve 60 further restricts Port F. Rotation of plug 78 results in the axial displacement of plug 78 and the axial repositioning of spring 42 to thereby adjust the biasing forces spring 42 exerts on spool valve member 64 and consequently the maximum pressure value of fluid discharged from valve 60. The use of non-adjustable pressure reducing valves and various other alternative pressure reducing valves may also be used with the present invention.

While the present invention has been described above with reference to a hydraulic system that combines both a steering gear assist device and a brake assist device, it may also be employed with other hydraulic devices and systems. For example, it is known to employ a single hydraulic fluid pump to power the fluid motor of a steering assist device and a second fluid motor associated with a radiator cooling fan. U.S. Pat. No. 5,802,848, for example, discloses a system having a steering gear assist device and a radiator cooling fan with a fluid motor powered by a single hydraulic fluid pump and is incorporated herein by reference. In alternative embodiments of the present invention, the priority valve and pressure reducing valve arrangement disclosed herein could be employed to facilitate the use of a single hydraulic fluid pump to power the fluid motors of both a steering gear assist device and that of a radiator cooling fan.

Furthermore, the priority valve and pressure reducing valve arrangement of the present system could be used to control the fluid flow associated with two hydraulic devices (e.g., a brake assist device, a steering gear assist device, a radiator fan having a fluid motor, or other hydraulic device), or two hydraulic circuits, wherein the priority valve and relief valve arrangement and the two associated hydraulic devices or circuits, form one portion of a larger complex hydraulic circuit.

In still other embodiments, a pressure reducing valve could be used in a hydraulic circuit without a priority valve to limit the pressure of the fluid being provided to a steering gear assist device or other hydraulic device. For example, a pressure reducing valve could be used in an integrated hydraulic circuit having both a brake assist device and a steering gear assist device but not a priority valve to enable the use of a steering gear assist device having a lower pressure relief value than that of the brake assist device. Or, a pressure reducing valve could be employed as described herein in a conventional hydraulic circuit for a steering gear assist device that does not include any other hydraulic devices to limit the pressure of the hydraulic fluid at the inlet of the steering gear assist device.

While this invention has been described as having an exemplary design, the present invention may be further modified within the spirit and scope of this disclosure. This application is therefore intended to cover any variations, uses, or adaptations of the invention using its general principles.

What is claimed is:

1. A vehicular hydraulic system comprising:
a hydraulic circuit having, arranged in series and in serial order along a primary flow path, a hydraulic pump, a first hydraulic application, a pressure reducing valve and a second hydraulic application;
wherein the hydraulic fluid pressure in said primary flow path between said hydraulic pump and said first hydraulic application can be elevated to a first threshold value; and
wherein said pressure reducing valve limits the maximum pressure of the hydraulic fluid discharged from said pressure reducing valve to a second threshold value, said first threshold value being greater than said second threshold value.

2. The vehicular hydraulic system of claim 1 wherein said first hydraulic application is a hydraulic brake booster device and said second hydraulic application is a hydraulic steering gear device.

3. The vehicular hydraulic system of claim 2 wherein said pressure reducing valve comprises a valve body defining a valve chamber, a spool valve member slidingly disposed in said valve chamber and having a first valve head and a second valve head, said first and second valve heads being sealingly engaged with said valve body and thereby sealingly partitioning said valve chamber into a central portion, a pilot portion and a return line portion;
said valve chamber having an inlet port receiving fluid flow from said primary flow path, an outlet port through which fluid is discharged into said primary flow path, a pilot port in fluid communication with said primary flow path downstream of said pressure reducing valve and upstream of said steering gear, and a return line port in fluid communication with said primary flow path downstream of said steering gear and upstream of said hydraulic pump;
said inlet port and said outlet port each being in fluid communication with said central portion of said valve chamber; said pilot port being in fluid communication with said pilot portion and said return line port being in fluid communication with said return line portion; and
wherein an increase in fluid pressure in said pilot portion relative to said return line portion relatively moves said spool valve member and thereby restricts fluid flow through said pressure reducing valve and reduces the pressure of hydraulic fluid discharged through said outlet port.

4. The vehicular hydraulic system of claim 3 further comprising a threaded member and a biasing member operably engaged with said spool valve member and said threaded member; external adjustment of said threaded member adjusting the operable position of said biasing member and thereby adjusting said second threshold value.

5. The vehicular hydraulic system of claim 3 further comprising a hydraulic reservoir in communication with said primary flow path at a location downstream of said steering gear and upstream of said hydraulic pump.

6. The vehicular hydraulic system of claim 3 wherein said hydraulic pump discharges hydraulic fluid at a substantially constant flow rate.

7. The vehicular hydraulic system of claim 3 further comprising a flow-splitting valve disposed in said hydraulic circuit downstream of said hydraulic pump and upstream of said brake booster;
wherein, in a first operating condition, substantially all of the hydraulic fluid discharged from said hydraulic pump flows along said primary flow path through said flow-splitting valve, to said brake booster, through said pressure reducing valve, to said steering gear and is returned to said hydraulic pump; and
wherein, when the hydraulic fluid pressure in said primary flow path between said hydraulic pump and said first hydraulic application is elevated to said first threshold value, said flow-splitting valve splits the hydraulic fluid discharged by said hydraulic pump into a first fluid flow which is communicated to said primary flow path upstream of said first hydraulic application and a second fluid flow which is communicated to a point in said primary flow path downstream of said first hydraulic application and upstream of said pressure-reducing valve.

8. The vehicular hydraulic system of claim 7 wherein said hydraulic pump discharges hydraulic fluid at a substantially constant flow rate and said hydraulic circuit further comprises a hydraulic reservoir in fluid communication with said primary flow path downstream of said steering gear and upstream of said hydraulic pump and wherein hydraulic fluid lines communicate fluid pressure within said hydraulic reservoir to said flow-splitting valve, said brake booster, said pressure reducing valve and said steering gear.

9. The vehicular hydraulic system of claim 8 further comprising a threaded member and a biasing member operably engaged with said spool valve member and said threaded member; external adjustment of said threaded member adjusting a biasing force exerted by said biasing member on said spool valve member and thereby adjusting said second threshold value.

10. A vehicular hydraulic system comprising:
a hydraulic circuit having, arranged in series and in serial order along a primary flow path, a hydraulic pump, a flow-splitting valve, a first hydraulic application, a pressure reducing valve and a second hydraulic application;
wherein, in a first operating condition, substantially all of the hydraulic fluid discharged from said hydraulic pump flows along said primary flow path through said flow-splitting valve, to said first hydraulic application, through said pressure reducing valve, to said second hydraulic application and is returned to said hydraulic pump;
wherein, when the hydraulic fluid pressure in said primary flow path between said hydraulic pump and said first hydraulic application is elevated to a first threshold value, said flow-splitting valve splits the hydraulic fluid discharged by said hydraulic pump into a first fluid flow which is communicated to said primary flow path upstream of said first hydraulic application and a second fluid flow which is communicated to a point in said primary flow path downstream of said first hydraulic application and upstream of said pressure-reducing valve; and
wherein said pressure reducing valve limits the maximum pressure of the hydraulic fluid discharged from said pressure reducing valve to a second threshold value, said first threshold value being greater than said second threshold value.

11. The vehicular hydraulic system of claim 10 wherein said first hydraulic application is a hydraulic brake booster device and said second hydraulic application is a hydraulic steering gear device.

12. The vehicular hydraulic system of claim 11 wherein said pressure reducing valve comprises a valve body defining a valve chamber, a spool valve member slidingly disposed in said valve chamber and having a first valve head and a second valve head, said first and second valve heads being sealingly engaged with said valve body and thereby sealingly partitioning said valve chamber into a central portion, a pilot portion and a return line portion;
said valve chamber having an inlet port receiving fluid flow from said primary flow path, an outlet port through which fluid is discharged into said primary flow path, a pilot port in fluid communication with said primary flow path downstream of said pressure reducing valve and upstream of said steering gear, and a return line port in fluid communication with said primary flow path downstream of said steering gear and upstream of said hydraulic pump;
said inlet port and said outlet port each being in fluid communication with said central portion of said valve chamber; said pilot port being in fluid communication with said pilot portion and said return line port being in fluid communication with said return line portion; and
wherein an increase in fluid pressure in said pilot portion relative to said return line portion relatively moves said spool valve member and thereby restricts fluid flow through said pressure reducing valve and reduces the pressure of hydraulic fluid discharged through said outlet port.

13. The vehicular hydraulic system of claim 12 further comprising a threaded member and a biasing member operably engaged with said spool valve member and said threaded member; external adjustment of said threaded member adjusting the operable position of said biasing member and thereby adjusting said second threshold value.

14. The vehicular hydraulic system of claim 12 further comprising a hydraulic reservoir in fluid communication with said primary flow path at a location downstream of said steering gear and upstream of said hydraulic pump.

15. The vehicular hydraulic system of claim 12 wherein said hydraulic pump discharges hydraulic fluid at a substantially constant flow rate.
